(19) United States
(12) Patent Application Publication
(10) Pub. No.: US 2008/0304839 A1
(43) Pub. Date: Dec. 11, 2008

(54) Image processing apparatus

(75) Inventors: Yuji Okamoto, Kyoto (JP); Naofumi Ueda, Kyoto (JP)

Correspondence Address: EDWARDS ANGELL PALMER & DODGE LLP, P.O. BOX 55874, BOSTON, MA, 02205, US

(73) Assignee: Sharp Kabushiki Kaisha, Osaka (JP)

(21) Appl. No.: 12/156,197

(22) Filed: May 30, 2008

(30) Foreign Application Priority Data
Jun. 7, 2007 (JP) 2007-151870

(51) Int. Cl. G03G 15/00

(52) U.S. Cl. 399/38

(57) ABSTRACT

In an image processing apparatus of the present invention, an image forming section for forming an image makes a part of line information which exists in the image different from other line information. For example, specific information is added by making a part of line information such as a frame line, a ruled line, or an under line, different from other line information. Specific information such as copying inhibition information and user information is added to a document, and thereby it is possible to prevent from affecting other image information different from conventional copying inhibition information and background pattern. Moreover, since the ruled line and the like is formed in black, it is possible to add the specific information or recognize the specific information even in a black-and-white image processing apparatus.

### BACKGROUND OF THE INVENTION

1. Field of the Invention

The present invention relates to an image processing apparatus capable of processing an image to which specific information such as copying inhibition information is added.

2. Description of the Related Art

Japanese Patent Laid-Open No. 7-38747 discloses an image processing apparatus for inhibiting or restricting the copying of a document when it is an important, top secret document. In the Japanese Patent Laid-Open No. 7-38747, it is configured such that a character in a document image is recognized by image data from an image memory to detect an underline drawn under the character, followed by determining whether or not the underline is a specific underline, and when the underline is the specific underline, the copying of the document is inhibited or restricted as it is an important confidential paper. Whether or not the underline is specific is determined by a thickness or a kind of the underline.

However, in the Japanese Patent Laid-Open No. 7-38747, since a thickness or a kind of an underline for providing specific information is limited to be specific one, degree of freedom in selection by the user who adds the specific information is reduced. Therefore, it is desired to employ an adding method with high degree of freedom as the specific information.

Further, conventionally, specific information to be added to a document such as copying inhibition information and user information has been subjected to an image formation by a color multifunctional peripheral. For example, specific information is added to a document by using yellow toner. This causes a problem that the specific information of yellow which has been added to the document can not be recognized when it is read as a black-and-white image, thus allowing unauthorized copying.

In view of the above described circumstance, it is an object of the present invention to provide an image processing apparatus capable of adding specific information or recognizing specific information without affecting other image information, or even in a black-and-white image processing apparatus, which is different from a conventional method of adding specific information by copying inhabitation information or background pattern.

### SUMMARY OF THE INVENTION

In order to achieve the foregoing object, the present invention includes an image forming section for forming an image, and a control section for controlling the image forming section so that specific information is added to the image, in which the control section makes a part of line information which exists in the image different from other line information so that different line information serves as the specific information, and adds the specific information to the image.

According to the configuration above, a part of line information (a frame line, a ruled line, and an underline) which exists in an image is made different from other line information to be served as specific information such as copying inhibition information and user information, and the specific information is added to a document, thus making it possible to prevent from affecting other image information, which is different from a conventional method of adding specific information by copying inhabitation information or background pattern. Moreover, since the ruled line and the like is formed in black, it is possible to add the specific information or recognize the specific information even in a black-and-white image processing apparatus.

As the specific information, a method of making a thickness of a line different from that of other lines can be employed. Specifically, the thickness of a straight-line from a specific intersection to another specific intersection is made different.

According to the configuration above, for example, the thickness of a plurality of straight-lines from intersections to intersections of ruled lines is varied to increase the combination thereof, making it possible to add a lot of specific information, and to reduce sense of incongruity given to the user.

As the specific information, the line information can be either one or more of a ruled line, an underline, and a partitioning line.

Among these pieces of line information, a shape of an intersection of lines is made different from that of intersections of other lines. Moreover, it is also possible that the shape of the leading edge of a line is made different from that of leading edges of other lines. Variation in the shape of the line edge enables to add a lot of specific information. When these pieces of the line information are a ruled line, an underline, or a partitioning line, it can be recognized to vary the thickness of the line or the shape of the edge part.

Further, it is also possible to make a density of a line partly different as the specific information. By making the density of the line different, a lot of information can be added like bar code.

Furthermore, a line interval or a line length of a dashed line is made different as the specific information. For example, by making the line interval different, a lot of information can be added like bar code.

Moreover, an image processing apparatus according to the present invention includes a reading section for image data, a recognizing section for reading specific information from the image data to perform a recognition, and a control section for performing a functional restriction based on the specific information recognized by the recognizing section, in which the specific information is such that a part of line information which exists in an image is made different from other line information, and the control section performs the functional restriction by the recognition of the specific information.

According to the configuration above, since the ruled line and the like is formed in black, it is possible to recognize the specific information to perform the functional restriction such as copying restriction even in a black-and-white image processing apparatus.

As described above, according to the present invention, specific information which is formed by making a part of line information different from other line information is added, and thereby it is possible to restrict functions of apparatuses such as copying inhibition without affecting other image information. Moreover, since the ruled line and the like is formed in black, it is possible to add the specific information or recognize the specific information even in a black-and-white image processing apparatus.

### BRIEF DESCRIPTION OF THE DRAWINGS

FIG. 1 is a configuration diagram of a digital copying machine to which an image processing apparatus as an embodiment of the present invention is applicable;

FIG. 2 is a configuration block diagram for illustrating the function provided in the image processing apparatus to which the present invention is applicable;

FIG. 3 shows an example of forming a frame line or a ruled line on a recording sheet;

FIG. 4 shows an example of forming an underline on a recording sheet;

FIG. 5 shows an example in which a slight gap is provided in an L-shaped part which is located at a corner portion of a frame line of a table and the like;

FIG. 6 shows an example in which a T-shaped part where ruled lines cross is formed into a different shape;

FIG. 7 shows an example in which a part where two lines cross is made swollen;

FIGS. 8 A), B), C) show an example in which recessed and projecting parts are provided on a ruled line, a partitioning line, and an underline;

FIGS. 9 A), B), C) show an example in which characteristic is imparted to a dashed line used for a ruled line or an underline; and

FIG. 10 shows an example in which the thickness of a line at a specified position in a table made of ruled lines is varied.

### DETAILED DESCRIPTION OF THE PREFERRED EMBODIMENTS

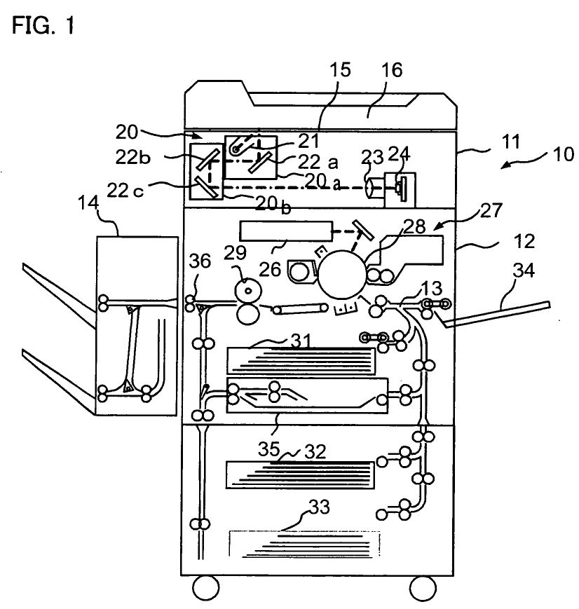

FIG. 1 illustrates a configuration example of a digital copying machine to which an image processing apparatus of the present invention is applicable. The image processing apparatus 10 is constituted as a digital copying machine including a scanner section 11 constituting a document reading section, and a laser printer section 12 constituting an image forming section.

The scanner section 11 comprises a document placement table 15 made of transparent glass, a reversing automatic document feeder (RADF) 16 for automatically supplying and feeding a document to the document placement table 15, and a scanner unit 20 for scanning and reading an image of the document laid on the document placement table 15.

The RADF 16, which includes a not-shown document tray, automatically feeds a plurality of documents set on the document tray at a time one by one to the document placement table 15 of the scanner unit 20. Moreover, the RADF 16 comprises a feeding path for single-sided documents, a feeding path for double-sided documents, a feeding path switching section for switching these feeding paths, a sensor group for grasping and managing the state of documents passing through each section, and a control section, and is operated such that the scanner unit 20 reads one side or both sides of a document depending on a selection of the operator.

The scanner unit 20 includes a lamp reflector assembly 21 for exposing the surface of the document to light, a charge coupled device (CCD) 24, and a first scanning unit 20a, a second scanning unit 20b and an optical lens 23 for guiding a reflected light image from the document to the CCD 24.

The reflected light image from the document is reflected by a first reflection mirror 22a included in the first scanning unit, and further reflected by second and third reflection mirrors 22b, 22c included in the second scanning unit 20b, thus the image is formed on the CCD 24 by the optical lens 23. At the CCD 24, the reflected light image from the document, the image of which has been formed by the optical lens 23, is converted into electrical image signals.

At the scanner section 11, with an associated operation of the RADF 16 and the scanner unit 20, while documents to be read are sequentially laid on the document placement table 15, the scanner unit 20 is moved along the lower face of the document placement table 15 to read document images.

In particular, it is controlled such that the first scanning section 20a travels at a constant speed V from left to right along the document placement table 15, and the second scanning section 20b travels at a speed V/2, half the speed V, in parallel to the same direction. This makes it possible that the images of the documents laid on the document placement table 15 are sequentially formed on the CCD 24 for each line to be read.

Image data which has been obtained by reading the document image by the scanner unit 20 is subjected to various processing and thereafter temporarily stored in an image memory. Then, the image in the image memory is read out depending on the output instruction for the image processing apparatus 10, and transferred to the laser printer section 12.

The laser printer section 12 includes a feeding system for a sheet which is a recording material on which an image is formed, a laser writing unit 26, and an electrophotographic process section 27 for forming the image.

The laser writing unit 26 has a semiconductor laser light source for emitting laser light depending on image data which has been read by the scanner unit 20 and stored in the image memory, or image data which has been transferred from an external apparatus, a polygonal mirror for deflecting the laser light at the constant angular speed, and an f-θ lens for correcting the laser light which has been deflected at the constant angular speed so as to be deflected at the constant angular speed on a photoreceptor drum 28 constituting the electrophotographic process section 27.

The electrophotographic process section 27 above is constituted by including, around the photoreceptor drum 28, a charging device, a developing device, a transferring device, a peeling device, a cleaning device, and a neutralization device, whose constitution is well known.

On the other hand, the feeding system for a sheet above includes a feeding section 13 for feeding a sheet, in particular, to a transfer position where the transferring device is disposed in the electrophotographic process section 27, cassette paper feeding apparatuses 31, 32, 33 for feeding the sheet to the feeding sections 13, a manual paper feeding apparatus 34 for suitably feeding the sheet of necessary size, a fixing device 29 for fixing a toner image which has been formed on the sheet after transferring, and a re-feeding path 35 for re-feeding the sheet to form the image again on the back face of the sheet after fixing.

Further, a post-processing apparatus 14 for receiving the sheet on which the image has been recorded and applying predetermined processing to the sheet, is disposed in the downstream side of the fixing device 29.

The image data, which has been read from the image memory in the laser writing unit 26 and the electrophotographic process section 27 as described above, is scanned with laser beam by the laser writing unit 26 so as to be formed as an electrostatic latent image on the surface of the photoreceptor drum, and the toner image which has been visualized by toner is electrostatically transferred and fixed onto the surface of the sheet which has been fed from either one of paper feeding sections in a multistage paper feeding unit. Then, the sheet formed with the image thereon has been formed is fed from the fixing device 29 into the post-processing apparatus 14 via a paper discharge roller 36.

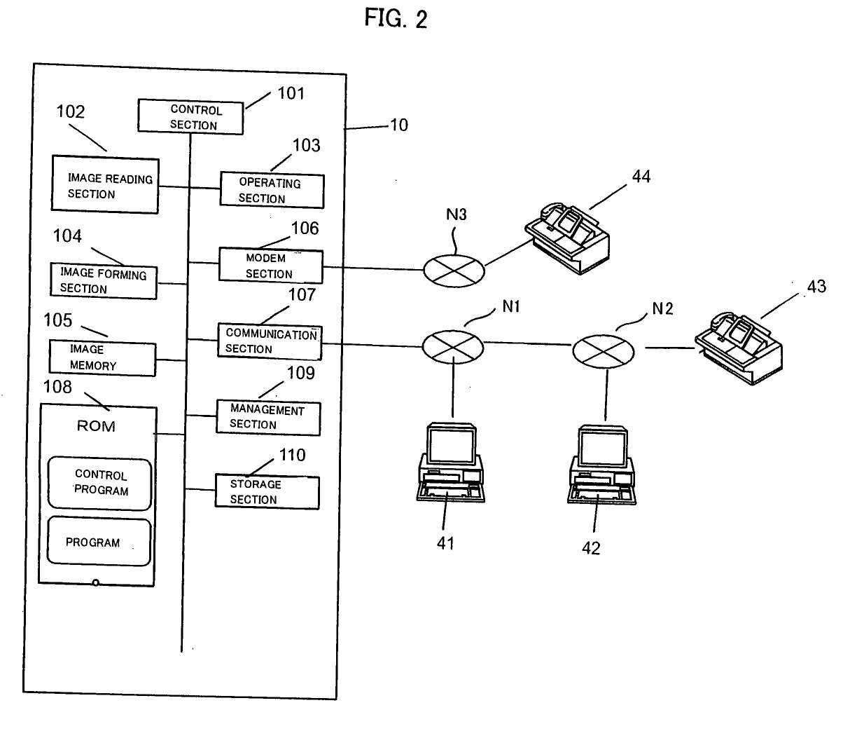

FIG. 2 illustrates the function provided in the image processing apparatus to which the present invention is applicable, which shows an example in which it is constituted as a multifunctional peripheral having the function of a copier, a printer, a facsimile apparatus, a scanner, and the like.

The configuration shown in FIG. 2 is applicable to the digital copying machine shown in FIG. 1. The image processing apparatus 10 includes a control section 101 which is made up of a CPU for performing the calculation, a RAM for storing temporal information associated with the calculation, and the like.

The control section 101 is connected to a ROM 108 for storing a control program to control the image processing apparatus 10, and a management section 109 which is a memory for storing management information to manage processing performed by the image processing apparatus 10.

The control section 101 is also connected to an image reading section 102 for reading an image which has been recorded on a recording sheet to create image data.

Furthermore, the control section 101 is connected to an image memory 105 for temporarily storing the image data, and an image forming section 104 for forming the image from the image data which has been stored in the image memory 105 to record on the recording sheet.

The image processing apparatus 10 causes the image memory 105 to temporarily store the image data which has been created by the image reading section 102, and thereafter can form the image at the image forming section 104. Thus, the image processing apparatus 10 functions as the copier.

Moreover, in FIG. 2, the control section 101 is connected to a modem section 106 for performing facsimile communication, and the modem section 106 is connected to a public line network N3. The image processing apparatus 10 can transmit the image data which has been created by the image reading section 102 to another facsimile apparatus 44 via the public line network N3 which is connected to the model section 106 by the facsimile communication.

Furthermore, the image processing apparatus 10 can receive the image data which has been transmitted from the another facsimile apparatus 44 via the public line network N3 and form the image at the image forming section 104 from the received image data. Thus, the image processing apparatus 10 functions as the facsimile apparatus.

Moreover, the control section 101 is connected to a communication section 107 for transmitting/receiving information to/from outside by the image processing section 10. The communication section 107 is connectable to a communication network N1 such as an in-house LAN, and the communication network N1 is connectable to one or more personal computers (PCs) 41. In a normal state where the image processing apparatus 10 is operated independently, the communication section 107 is connected to the communication network N1, and exchanges information with the PC 41 via the communication network N1.

The image processing apparatus 10 can transmit the image data which has been created by the image reading section 102 from the communication section 107 to the PC 41. Thus, the image processing apparatus 10 functions as the scanner.

Further, the image processing apparatus 10 can receive the image data which has been transmitted from the PC 41 at the communication section 107 and form the image at the image forming section 104 from the received image data. Thus, the image processing apparatus 10 functions as the printer.

The communication network N1 is further connected to a wide-area communication network N2 such as the Internet. The communication section 107 can receive the image data between an information processing apparatus 42 or the another facsimile apparatus 43, which is connected to the wide-area communication network N2, via the communication network N1 and the wide-area communication network N2, by transmitting an electronic mail with the image data attached thereto. Thus the image processing apparatus 10 functions as the internet facsimile apparatus.

Further, the control section 101 is connected to an operating section 103 for receiving operation from the user. The operating section 103 is made up of a display section such as a liquid crystal panel for displaying information necessary for the operation, and an input section such as a touch panel or ten keys to which information such as control instruction is inputted by the operation of the user.

The control section 101 is also connected to a storage section 110 which is made up of such as a hard disc or an optical disc. The storage section 110 stores image data related to image processing such as the image data which has been created by the image reading section 102.

When the configuration of FIG. 2 is applied to the digital copying machine of FIG.1, the scanner section 11 corresponds to the image reading section 102 above, and the laser printer section 12 corresponds to the image forming section 104 above. That is, the image data of the document image, which has been read at the scanner section 11 of FIG. 1, is stored in the image memory 105 shown in FIG. 2, and depending on the output instruction to the digital multifunctional peripheral, the image data is read from the image memory 105 and transmitted to the laser printer section 12. At the laser printer section 12, image formation is performed on a sheet according to the image data.

It is configured such that the image processing apparatus of the present invention includes the image forming section 104 for forming the image and the reading section 102 for image data, as described above, and further the control section 101 for controlling these sections, which includes a recognizing section for reading and recognizing specific information in the image data, controls various functional sections such as the image forming section 104 based on the recognized result.

In particular, the control section 101 controls the image forming section 104 so that specific information is added to the image. The specific information is added by making a part of line information which exists in the image different from other line information. For example, specific information below can be added. Further, the control section 101 performs a functional restriction based on the specific information which has been recognized by the recognizing section. For example, when the specific information is to be treated as confidential document, the control section 101 controls the image forming section 104 so as to inhibit copying of the document.

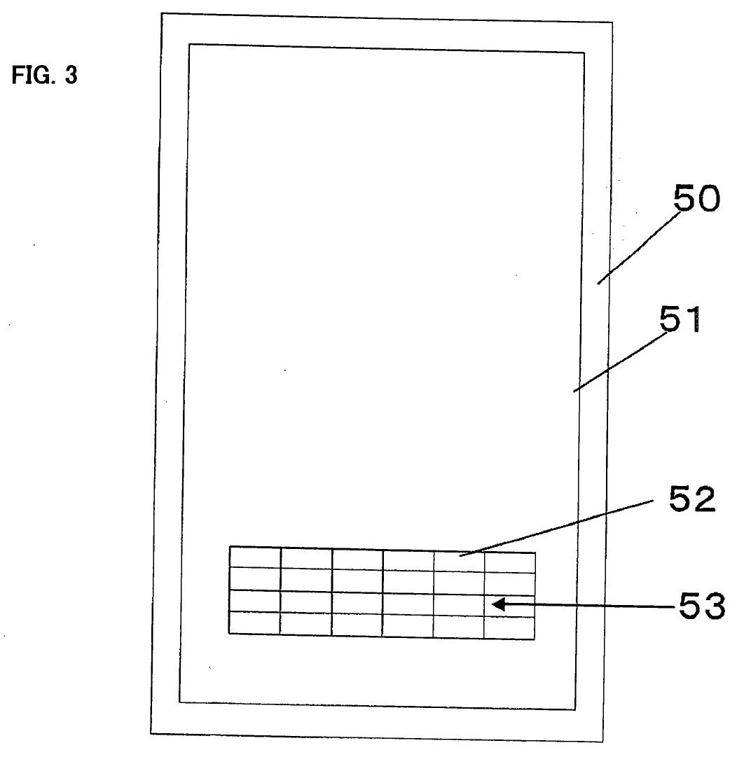

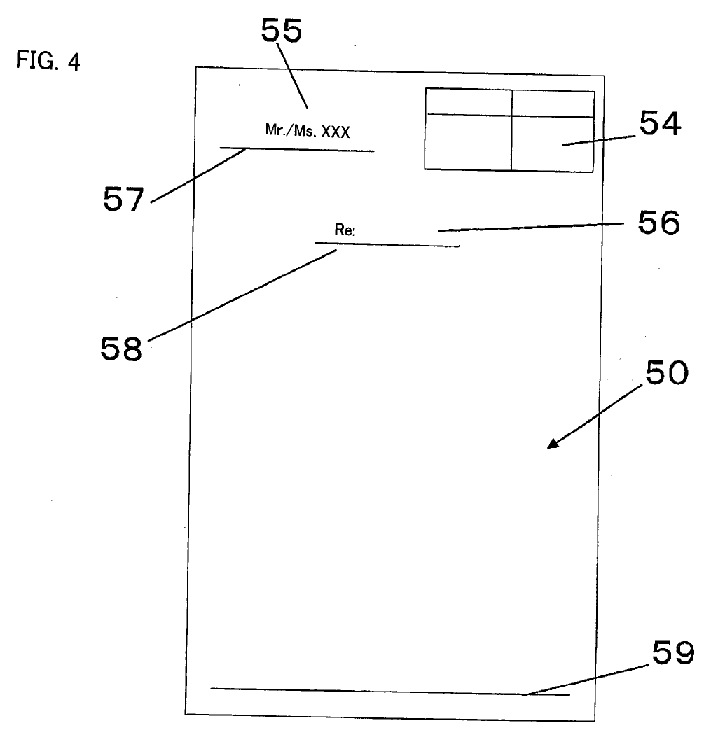

FIGS. 3, 4 show a form when printing is performed on a recording sheet 50. In FIG. 3, a frame line 51 is arranged at the outer periphery of the recording sheet 50, and a table 53 constituted by a ruled line 52 is provided.

In FIG. 4, a table 54 is provided in the upper right part, underlines 57, 58 are provided in a destination 55 and a title 56, and a partitioning line 59 is provided in the lower part of the recording sheet 50.

Thus, since many linear components are used even in a normal document or sheet, it is possible to add hidden information (specific information) such as copying inhibition information by imparting characteristic to the line. Accordingly, since the hidden information (specific information) can be added without changing the form of the sheet, and therefore sense of incongruity is not given to the user.

Here, as the specific information to be added, a part of line information which exists in the image is made different from other line information, and this different line information can be served as the specific information.

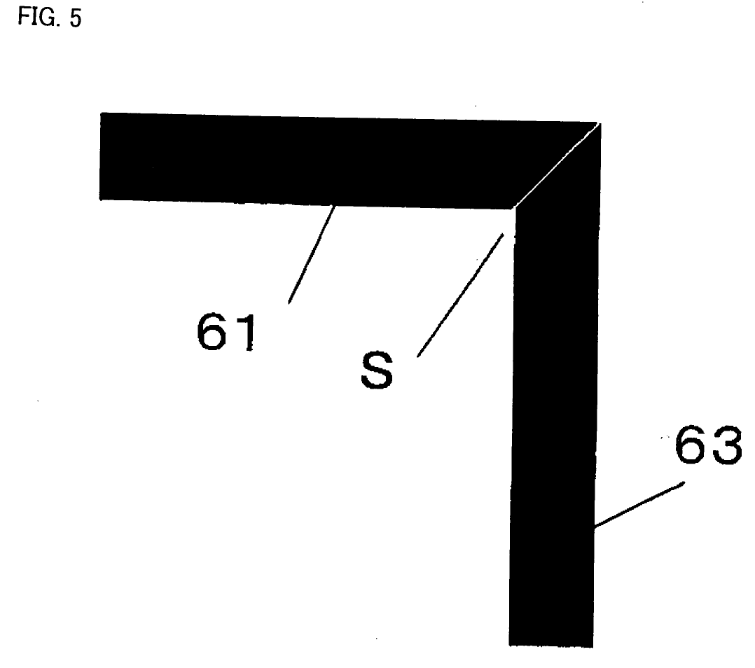

FIGS. 5 to 10 show specific examples for adding specific information to line information. In FIG. 5, a slight gap S is provided in a corner part where a transverse ruled line 61 and a longitudinal ruled line 63 cross in the table and the like, that is, in an L-shaped part of a frame line and the like.

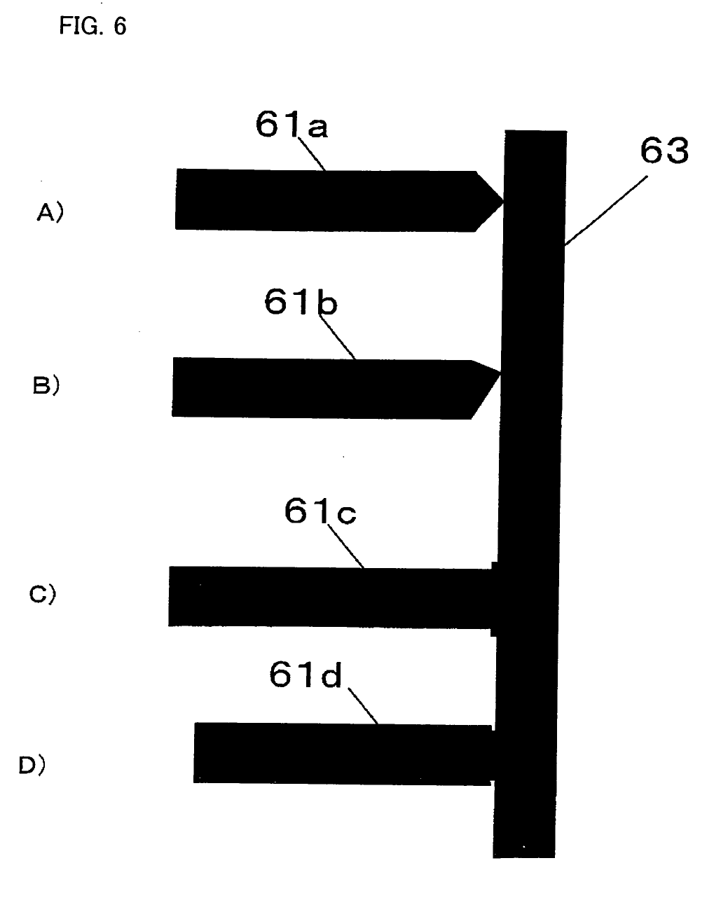

In FIG. 6, characteristic is imparted to a T-shaped part where transverse ruled lines 61a to 61d and the longitudinal ruled line 63 cross. In FIGS. 6A), 6B), leading edges of parts where the transverse ruled lines 61a, 61b and the longitudinal ruled line 63 overlap is formed into arrow shapes. A) denotes the symmetrical arrow shape, and B) denotes the asymmetrical arrow shape. In FIGS. 6C), 6D), the thickness of parts where the transverse ruled lines 61c, 61d and the longitudinal ruled line 63 overlap is varied. C) denotes an example of being formed into a thick line shape, and D) denotes an example of being formed into a thin line shape.

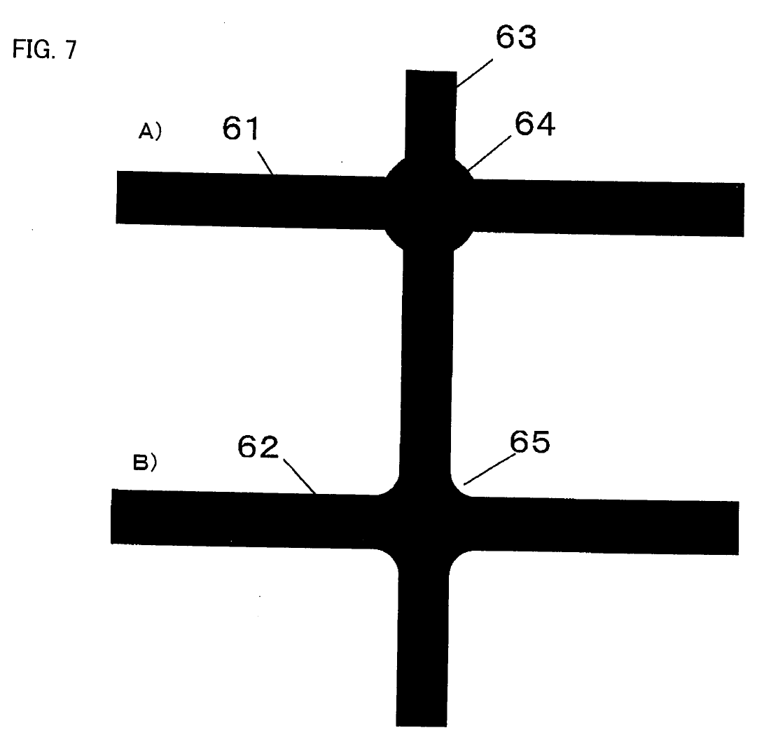

In FIG. 7, characteristic is imparted to parts where the longitudinal ruled line 63 crosses with the two horizontal transverse lines 61, 62. In the upper crossing part A), the crossing shape is formed as a circular-shaped adding part 64, and in the lower crossing part B), an R-shaped adding portion 65 is formed.

As described above, many transverse ruled lines and longitudinal ruled lines cross with each other to form grids (cells) in the table, so that the lines cross with each other and many intersections exist. Then, a lot of information can be added to the intersections. Moreover, by specifying the positions of the intersections in the table, it is possible to add a lot of hidden information, and to weight the information based on the number of the information, or the presence of the specific information by the specific positions, further the shape of the specific information to be added.

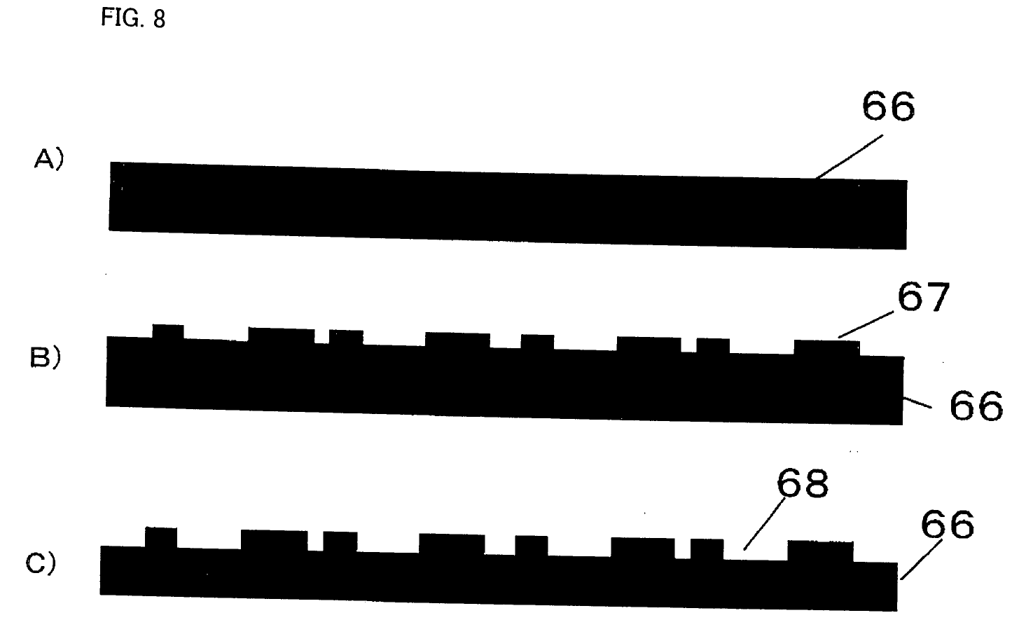

In FIG. 8, recessed and projecting parts are provided on a ruled line, a partitioning line, and an underline, and thereby a plurality of information is added similar to bar code. FIG. 8A) shows the thickness of a normal line 66. In FIG. 8B), a plurality of projecting parts 67 are formed at intervals on the line of FIG. 8A). The intervals between the projecting parts 67 can be suitably selected to add a plurality of information like bar code. In FIG. 8C), a plurality of recessed parts 68 are formed along the line 66 of FIG. 8A). The intervals between the recessed parts can be suitably selected. In the depth of the recessed part or the height of the rejecting part, for example, when printing is performed with the resolution of 600 DPI (dot per inch), recessed and projecting parts with dots of around 2 to 3 are added so that the specific information can be added. With such a height (depth) with dots of around 2 to 3, it is possible to add the specific information without affecting the image.

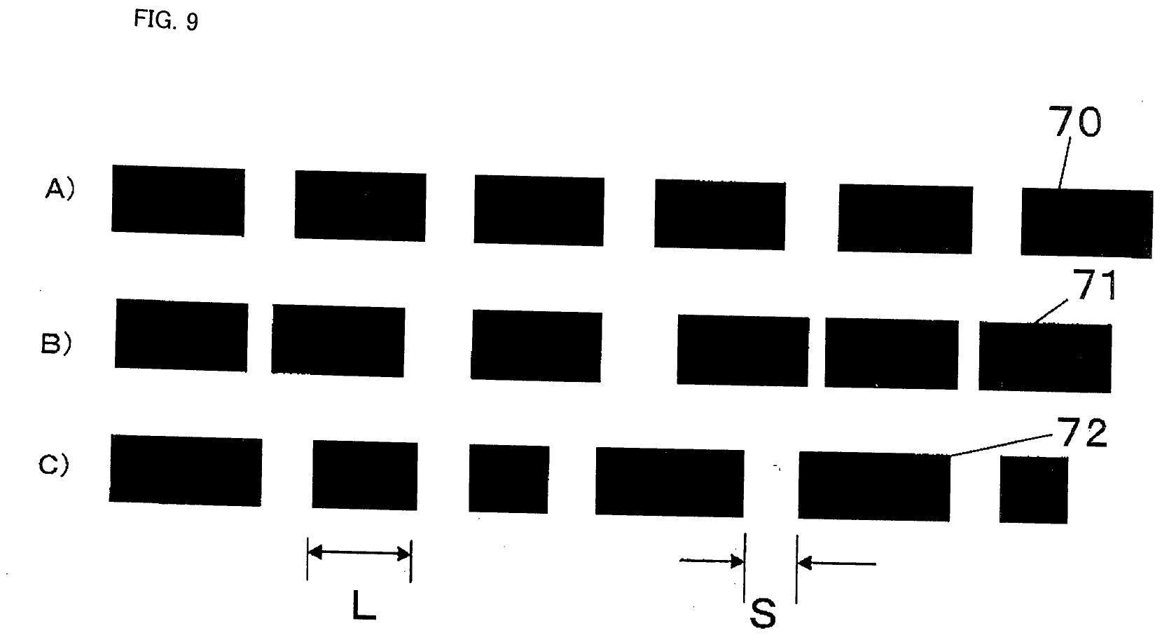

In FIGS. 9A), 9B), 9C), characteristic is imparted to dotted lines 70, 71, 72 used for a ruled line or an underline, where the length (L) of the line, the space (S), or both of them are varied, thus making it possible to add a plurality of information like bar code.

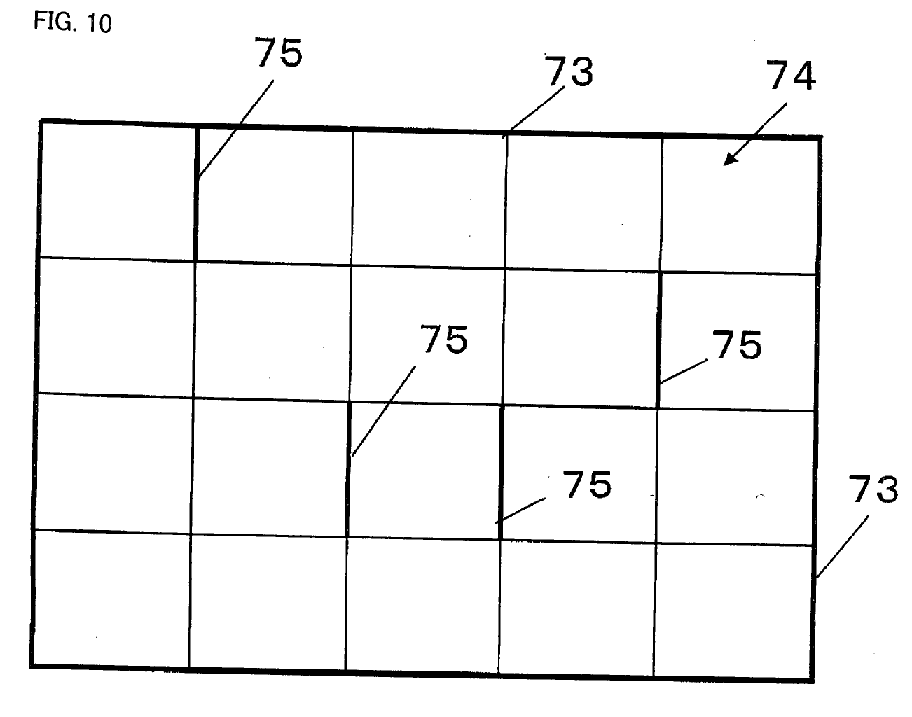

In FIG. 10, the thickness of lines 75 at specified positions in a table 74 constituted by ruled lines 73 are varied, and a plurality of information can be added by the size of the table and the positions of varying the thickness of the line.

As described above, specific information such as copying inhibition information is added to linear component which exists on the face of a normal recording sheet, and thereby it is possible to add hidden information without giving sense of incongruity to the user, or without affecting the printed image.

Moreover, when adding hidden information to a frame line or a ruled line, the position of adding the information, such as the upper right part of the recording sheet, is specified, thus making it easy to detect in reading the hidden information. Further, by distributing hidden information over the recording sheet, influence degree to the image can be further reduced.

What is claimed is:

1. An image processing apparatus, comprising:
an image forming section for forming an image; and
a control section for controlling the image forming section so that specific information is added to the image, wherein
the control section makes a part of line information which exists in the image different from other line information so that the different line information serves as the specific information, and adds the specific information to the image.

2. The image processing apparatus according to claim 1, wherein:
a thickness of a line from a specific intersection to another specific intersection is made different as the specific information.

3. The image processing apparatus according to claim 1, wherein:
a shape of an intersection of lines is made different from a shape of an intersection of other lines as the specific information.

4. The image processing apparatus according to claim 1, wherein:
a shape of a leading edge of a line is made different from a shape of a leading edge of another line as the specific information.

5. The image processing apparatus according to claim 1, wherein:
the line information is either one or more of a ruled line, an underline, and a partitioning line.

6. The image processing apparatus according to claim 1, wherein:
a density of a line is made partly different as the specific information.

7. The image processing apparatus according to claim 1, wherein:
at least one of a length and a line interval of a dashed line is made different as the specific information.

8. The image processing apparatus according to claim 1, wherein:
a recessing part or a projecting part is provided on a line itself as the specific information.

9. An image processing apparatus, comprising:
a reading section for image data;
a recognizing section for reading specific information from the image data to perform a recognition; and
a control section for performing a functional restriction based on the specific information recognized by the recognizing section, wherein
the specific information is such that a part of line information which exists in an image is made different from other line information, and
the control section performs the functional restriction by the recognition of the specific information.
